(19) United States
(12) Patent Application Publication
(10) Pub. No.: US 2025/0198396 A1
(43) Pub. Date: Jun. 19, 2025

(54) HIGH-POWER DENSITY ELECTRIC PROPULSION SYSTEM

(71) Applicant: CALIFORNIA INSTITUTE OF TECHNOLOGY, Pasadena, CA (US)

(72) Inventors: Richard R. HOFER, Monrovia, CA (US); Jacob B. SIMMONDS, Pasadena, CA (US); James E. POLK, Pasadena, CA (US); Dan M. GOEBEL, Tarzana, CA (US)

(21) Appl. No.: 18/628,616

(22) Filed: Apr. 5, 2024

Related U.S. Application Data
(60) Provisional application No. 63/458,370, filed on Apr. 10, 2023.

(51) Int. Cl. F03H 1/00; B64G 1/40

(52) U.S. Cl. CPC F03H 1/0031; B64G 1/413; F03H 1/0018

(57) ABSTRACT

A high-power density electric propulsion (EP) system is presented. High-power density functionality of the EP system is provided via thermal management structures that separately manage heat from a discharge chamber with electrically conductive inner/outer walls and an electromagnetic circuit of the EP system. The thermal management structures include separate radiators for rejection of heat from the discharge chamber and the electromagnetic circuit, the heat coupled to the radiators via respective thermal shunts. The thermal shunts include radially inwardly and/or outwardly projecting heat conducting structures that are thermally coupled to the discharge chamber and the electromagnetic circuit. Openings formed in annular structures of the electromagnetic circuit allow radial projection of the thermal shunts.

### CROSS REFERENCE TO RELATED APPLICATIONS

The present application claims priority to and the benefit of co-pending U.S. provisional patent application Ser. No. 63/458,370 entitled “High-Power Density Hall Thrusters”, filed on Apr. 10, 2023, the disclosure of which is incorporated herein by reference in its entirety.

### STATEMENT OF GOVERNMENT GRANT

This invention was made with government support under Grant No. 80NMO0018D0004 awarded by NASA (JPL). The government has certain rights in the invention.

### TECHNICAL FIELD

The present disclosure relates to electric propulsion systems. More particularly, it relates to thermal management of electric propulsion systems for operation at high power densities.

### BACKGROUND

Electric propulsion (EP) systems (e.g., Hall thrusters, gridded ion thrusters) use applied electric and magnetic fields to accelerate ions to extremely high velocities to generate thrust for a spacecraft. They are one of the most efficient forms of thrust available to modern spacecraft and are now regularly flown on commercial, military, and civil space missions. EP systems offer several benefits for the deep-space missions typically flown in the civil space sector, including not only higher delivered mass, but lesser appreciated capabilities such as launch window flexibility, the elimination of critical events like orbit insertion, and shorter flight times for certain missions that would otherwise require multiple planetary fly-bys.

Methods to achieve efficient, high specific impulse (e.g., greater than 3000 s) operation in EP systems, such as Hall thrusters, have been demonstrated. Combined with magnetic shielding, high specific impulse Hall thrusters are now possible with propellant throughput capabilities (i.e., long life) that are necessary for high velocity change (e.g., delta-V greater than 10 km/s) missions across the solar system. A conducting wall, magnetically shielded Hall thruster, which includes an annular discharge chamber with an inner wall made of a conductive material, such as a metal, is described in, e.g., U.S. Pat. No. 9,453,502, the description of which is incorporated herein by reference in its entirety.

Previous demonstrations have shown that efficient, high specific impulse operation in Hall thrusters is possible when combined with magnetic shielding, allowing for propellant throughput capabilities necessary for high delta-V missions. However, these systems have relatively narrow power throttling ratios (i.e., the ratio of the maximum power over the minimum power that the thruster is operated) over which high specific impulse can be maintained. This is due to plasma instabilities that emerge, typically at voltages greater than 500 V, when magnetically shielded thrusters are throttled to lower power at constant voltage (i.e., constant specific impulse), limiting the power throttling ratio over which high specific impulse can be maintained.

While throttling the voltage as power decreases can maintain the current in the thruster above the instability threshold, this requires a decrease in specific impulse and leads to higher propellant usage compared to maintaining a constant specific impulse. Efforts to mitigate these instabilities have only been partially successful, necessitating the development of different solutions to achieve high specific impulse over wide power throttling ratios (e.g., ratios equal to or greater than 2:1).

In some cases, the instability in magnetically shielded Hall thrusters can be avoided by operating the thruster at constant voltage while maintaining the current above the threshold. However, it has been found that as the voltage is increased, the current threshold for instability also increases. This means that in order to avoid instability and have significant power throttling at constant specific impulse, the power density of the thruster must exceed previously demonstrated capabilities.

While increasing power density can improve performance, it may negatively impact the thruster's life, stability, and thermal margin. However, for a magnetically shielded Hall thruster, the long-life capabilities far exceed typical deep-space mission requirements already and experiments have shown that stability is not a serious concern, leaving considerations of thermal margin as the primary challenge.

In view of the above, teachings according to the present disclosure address challenges in thermal management of electric propulsion systems, such as Hall thrusters, for high-power density operation.

### SUMMARY

According to a first aspect of the present disclosure, high-power density electric propulsion (EP) system is presented, comprising: a discharge chamber with a longitudinal extension according to an axial direction of the EP system, the discharge chamber comprising an annular inner wall and an annular outer wall made of an electrically conductive material; an electromagnetic circuit for generation in the discharge chamber of a magnetic field according to a radial direction; a segmented annular radiator surrounding the discharge chamber and the electromagnetic circuit; and a plurality of first thermal shunts radially outwardly projecting from the annular outer wall of the discharge chamber to make contact with the segmented annular radiator.

According to a second aspect of the present disclosure, a high-power density magnetically shielded Hall thruster is presented, comprising: a discharge chamber with a longitudinal extension according to an axial direction of the Hall thruster, the discharge chamber made of an electrically conductive material; an electromagnetic circuit for generation in the discharge chamber of a magnetic field according to a radial direction, the electromagnetic circuit comprising an inner electromagnetic circuit and an outer electromagnetic circuit; a segmented annular radiator surrounding the outer electromagnetic circuit; a plurality of first thermal shunts radially outwardly projecting from the discharge chamber to make contact with a first segment of the segmented annular radiator through respective plurality of openings formed in the outer electromagnetic circuit; and a plurality of second thermal shunts radially inwardly projecting from a second segment of the segmented annular radiator that is separate from the first segment to make contact with the inner electromagnetic circuit.

According to a third aspect of the present disclosure, a method for operating a magnetically shielded Hall thruster at higher power densities is presented, the method comprising: fabricating a discharge chamber of the Hall thruster from electrically conductive material; forming a plurality of openings in an outer electromagnetic circuit of the Hall thruster and arranging the outer electromagnetic circuit outwardly the discharge chamber; arranging an inner electromagnetic circuit of the Hall thruster inwardly the discharge chamber; arranging a segmented annular radiator outwardly the outer electromagnetic circuit; radially outwardly projecting a plurality of first thermal shunts from the discharge chamber to make contact with a first segment of the segmented annular radiator through the plurality of openings; radially inwardly projecting a plurality of second thermal shunts from a second segment of the segmented annular radiator that is separate from the first segment to make contact with the inner electromagnetic circuit; based on the radially outwardly projecting and the radially inwardly projecting, rejecting heat generated at the discharge chamber and the inner electromagnetic circuit independently from one another, thereby increasing efficiency of thermal management of the Hall thruster; and based on the increasing efficiency of thermal management, operating the Hall thruster at higher power densities

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1A shows a picture of a prior art electric propulsion (EP) system.

FIG. 1B shows a simplified cross-sectional schematic of the prior art EP system of FIG. 1A.

FIG. 2A shows partitioning of structures of an EP system considered for thermal management of a high-power density EP system according to the present disclosure.

FIG. 2B shows details of thermally conductive structures of a high-power density EP system according to an embodiment of the present disclosure.

FIG. 2C shows details according to an exemplary embodiment of the present disclosure for connecting of the thermally conductive structures of FIG. 2B.

FIG. 3A shows a simplified cross-sectional schematic of a high-power density EP system according to an embodiment of the present disclosure at a first angular view.

FIG. 3B shows a simplified cross-sectional schematic of a high-power density EP system according to an embodiment of the present disclosure at a second angular view.

FIG. 4 shows a simplified cross-sectional schematic of a high-power density EP system according to another embodiment of the present disclosure.

FIG. 5A shows exploded top and bottom views of the high-power density EP system of FIG. 3A and FIG. 3B.

FIG. 5B shows the high-power density EP system of FIG. 3A and FIG. 3B in an assembled state.

Like reference numbers and designations in the various drawings indicate like elements.

### DETAILED DESCRIPTION

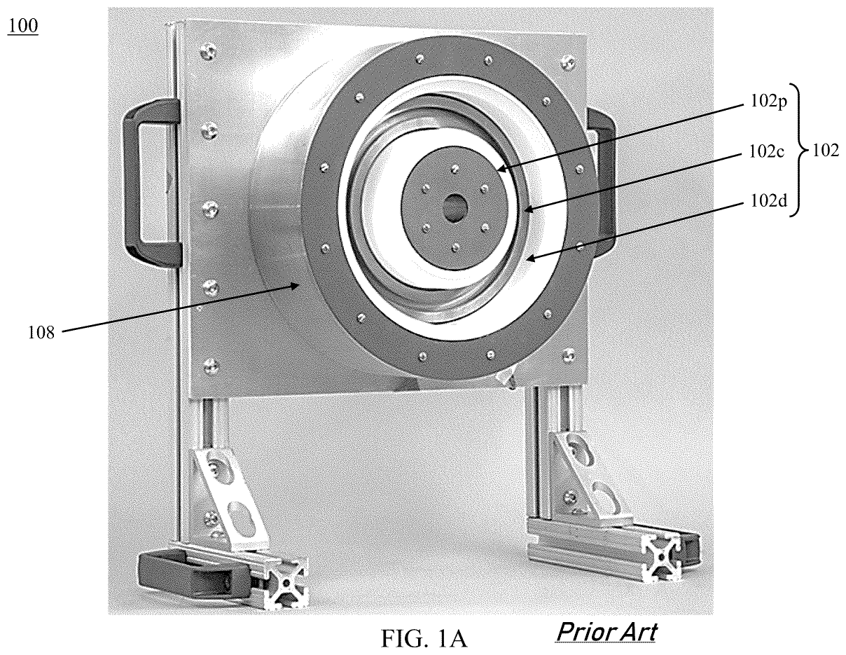

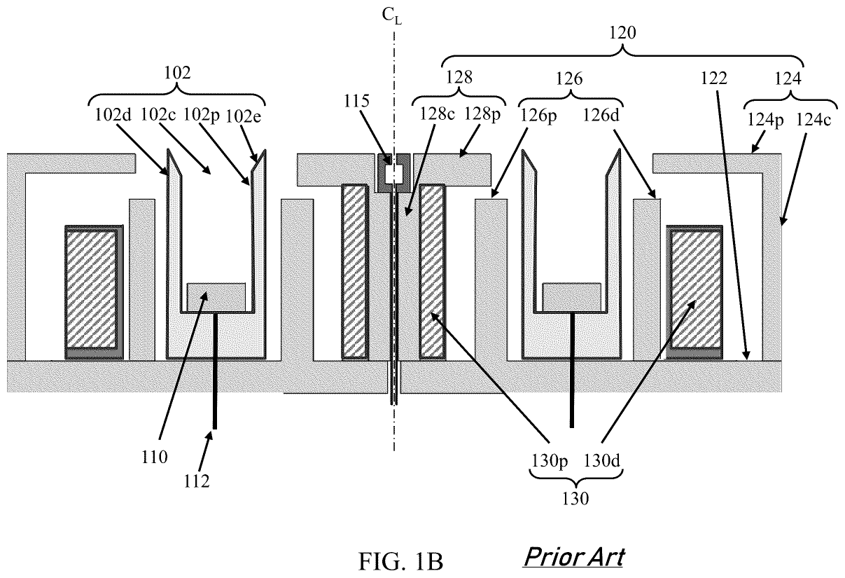

FIG. 1A shows a picture of a prior art electric propulsion (EP) system (100a). As shown in FIG. 1A, the EP system (100) may include an axial symmetry about a center axis (e.g., CL of FIG. 1B) about which (annular) elements/structures of the EP system (100) may be arranged. These include, for example, a (plasma) discharge chamber (102 e.g., discharge channel) laterally bounded by outer wall (102d, distal to the center axis, CL) and inner wall (102p, proximal to the center axis, CL) that may be made from insulating and/or conductive material. Within the inner space (102c, channel) of the discharge chamber (102), propellant ions may be accelerated via electric fields (e.g., Hall effect or electric grid electrodes) produced in the EP system (100). Operation of the EP system (100) may be further based on magnetic field lines produced within the inner space (102c) of the discharge chamber (102) according to methods and techniques known to a person skilled in the art. Further details of internal elements of the prior art EP system (100) for an exemplary case of a Hall thruster are described with reference to FIG. 1B.

FIG. 1B shows a simplified cross-sectional schematic of the prior art EP system (100) of FIG. 1A for an exemplary case of a Hall thruster. A Hall thruster typically uses a gas that can be ionized, such as xenon, as the material that is accelerated by the thruster, which results in an equal and opposite acceleration experienced by the thruster (and the object/spacecraft to which it is attached). Xenon gas may be used because of its high atomic weight and low ionization potential. Other materials that can be used as propellants may include krypton, argon, iodine, bismuth, magnesium, or zinc.

As shown in FIG. 1B, within the inner space (102c) of the annular discharge chamber (102) bounded by walls (102p, 102d), an anode/gas distributor (110) coupled to an inlet (112) for feeding of propellant gas may be provided. In conjunction with the anode/gas distributor (110), a cathode neutralizer (115, e.g., comprising a hollow cathode) may be provided that generates free electrons, so that a voltage applied between the anode (e.g., 110) and the cathode (115) provides a means for free electrons to flow from the cathode (115) through the discharge chamber (102) and be collected at the anode (110).

With continued reference to FIG. 1B, symmetrically arranged (about the center axis, CL) are elements/structures (120, 130) that form an electromagnetic circuit of the Hall thruster. The electromagnetic circuit (120, 130) includes a magnetic core (120) made of a magnetic material (e.g., soft magnetic material) and an electromagnetic coil system (130) that includes an inner electromagnetic coil (130p, proximal to the center axis, CL) and an outer electromagnetic coil (130d, distal to the center axis, CL). Within the inner space (102c) of the discharge chamber (102), the electromagnetic circuit (120, 130) may generate a radial magnetic field that is perpendicular to the electric field produced between the anode (e.g., 110) and the cathode (115). It should be noted that in some implementations, the inner/outer electromagnetic coils (130p, 130d) may include or be replaced with magnets, such as, for example, annular magnets to produce the radial magnetic field in (or about) the discharge chamber (102).

The magnetic core (120) of the prior art EP system shown in FIG. 1B may include a baseplate (122) upon which elements (124, 126, 128) of the magnetic core (120) may be fastened (e.g., bolted, fixated, mounted, connected, etc.). Such elements include an outer core structure (124) that includes a laterally arranged axial extension (124c, e.g., core) and a top radial extension (124p, e.g., pole) that inwardly extends towards the center axis, CL; an inner core structure (128) that includes a centrally arranged axial extension (128c, e.g., core) and a top radial extension (128p, e.g., pole) that outwardly extends away from the center axis, CL. Further included in the magnetic core (120) is a screen structure (126) that includes an inner screen (126p) arranged between the discharge chamber (102) and the inner core structure (128), and an outer screen (126d) arranged between the discharge chamber (102) and the outer core structure (124). The electromagnetic circuit (120, 130) may be described as comprising an inner electromagnetic (sub-) circuit that may include elements (128, 130p, 126p) arranged over an inner region/surface of the baseplate (122), and an outer electromagnetic (sub-) circuit that may include elements (124, 126d, 130d) arranged over an outer region/surface of the baseplate (122).

It should be noted that in some implementations, as shown in FIG. 1B, the cathode (115) may be arranged centrally within a region/cavity formed within the element (128), while in other implementations the cathode (115) may be arranged somewhere at a vicinity of an exit plane of the discharge chamber (102, e.g., plane orthogonal to CL and containing elements 124p and 128p). Choice of arrangement of the cathode (115) may be based on design goals and performances of the EP system. Teachings according to the present disclosure may equally apply to an arrangement of the cathode (115) according to FIG. 1B or otherwise. Some benefits of arranging of the cathode (115) according to FIG. 1B may be provided for magnetically shielded EP systems with walls (102d, 102p) of the discharge chamber (102) entirely made of a conductive material (e.g., metal). In magnetically shielded EP systems, and independently of material choice for the walls (e.g., walls 102d, 102p made of conductive or insulating material), edges of the walls (102d, 102p) may include slopes (102e) to further participate in the shielding of the walls (102d, 102p) from the erosive effects of the plasma, as described, for example, in the above referenced U.S. Pat. No. 9,453,502.

In an EP system, such as the prior art EP system (100) shown in FIGS. 1A/1B, thermal loads arise from plasma power deposition in the discharge chamber (102) and hollow cathode (115), as well as resistive heating in the electromagnetic coil system (130). While a significant portion of the thermal load (e.g., dissipated power, heat) may be radiated from the discharge chamber (102), the remaining thermal load must be conducted to exterior surfaces of the EP system (e.g., 108 of FIG. 1A) for rejection (e.g., into the vacuum of space) in order to avoid stressing of materials and/or structures of the EP system.

When the prior art EP system (100) of FIG. 1B is a conventional Hall thruster, a ceramic material such as boron nitride may form the annular walls (102d, 102p) of the discharge chamber (102), with the anode electrode and gas distributor (110) integrated into a subassembly that is combined with the ceramic material to form the discharge chamber assembly (102, 110). Choice of the ceramic material may be made foremost for its electrical insulating properties and high temperature resistance and not for its thermal conductivity and/or thermal emissivity, as operation of the EP system at high temperatures in a range of several hundreds of degrees centigrade (e.g., 300 to over 600 degrees) may be tolerated. Furthermore, various elements/structures of the discharge chamber assembly (102, 110) may be bolted to one another via fasteners which may limit a thermal conductance path/surface for flow of heat to the areas surrounding the fasteners and therefore provide poor contact conductance interfaces. In other words, the discharge chamber assembly (102, 110) of a conventional Hall thruster that includes discharge chamber walls (102d, 102p) made of electrical insulating material may result in poor contact conductance interfaces, low thermal conductivity, and modest thermal emissivity, all of which may be considered as drawbacks for efficient cooling of an EP system.

On the other hand, when the prior art EP system (100) of FIG. 1B includes electrically conducting annular walls (102d, 102p), such as for example, graphite or metal, then a higher axial and radial positional accuracy of elements/structures of the discharge chamber assembly (110, 112) relative to the magnetic field generated by the electromagnetic circuit (120, 130), or in other words, relative to the elements/structures of the electromagnetic circuit (120, 130), may be required in order to maintain a desired direction of a current that flows within the discharge chamber assembly (102, 110). In other words, efficiency of operation, and therefore reduction in wasted energy (e.g., dissipated heat), of such EP system (Hall thruster) may require advanced (and costly) manufacturing/production methods which may therefore limit its viability.

Above challenges with respect to a prior art EP system are further accentuated in high-power density operation where even higher operating temperatures are expected. As known to a person skilled in the art, power density of an EP system represents a power per unit area which may be defined as the product of the operating voltage and operating current of the EP system divided by the annular area of the discharge chamber. In the present disclosure, an EP system with a power density greater than about 50-60 W/cm² may be regarded as a high-power density EP system.

The high-power density EP system according to the present disclosure overcomes such challenges via an integrated, conducting-wall, magnetically-shielded discharge chamber design to more efficiently manage heat load, along with a segmented radiator design that separately manages heat from the discharge chamber and the electromagnetic circuit. Furthermore, the EP system according to the present disclosure includes built-in features (e.g., structures, interferences, etc.) to allow interlocking and precise alignment of the various structures of the present EP system. Such features may be provided by way of openings and/or recessed areas and complementary protrusions and/or ridged areas that establish precise alignment of the various structures. According to an embodiment of the present disclosure, the protrusions may include radially outwardly and/or inwardly protrusions that further participate in the thermal management of the EP system. According to an embodiment of the present disclosure, the radially outwardly/inwardly protrusions function as thermal shunts that (efficiently) conduct heat from internal structures of the EP system to an (external) segmented radiator that surrounds the EP system. According to an embodiment of the present disclosure, the segmented radiator comprises a first radiator for rejection of heat from the discharge chamber, and a second radiator for rejection of heat from the electromagnetic circuit. According to an embodiment of the present disclosure, the first radiator and the second radiator are separated by a gap and therefore are not in physical contact to one another. It should be noted that teachings according to the present disclosure may not be limited to a specific EP system, such as, for example, a magnetically shielded Hall thruster or a magnetically shielded Hall thruster with a discharge chamber made of electrically conductive material. Rather, aspects of the present teachings, including, for example, the described segmented radiator design, interlocking features, and/or thermals shunts, may be used and adapted for effective thermal management in a variety of EP systems, including, for example, unshielded Hall thrusters or Hall thrusters with discharge chambers that include electrically insulating walls.

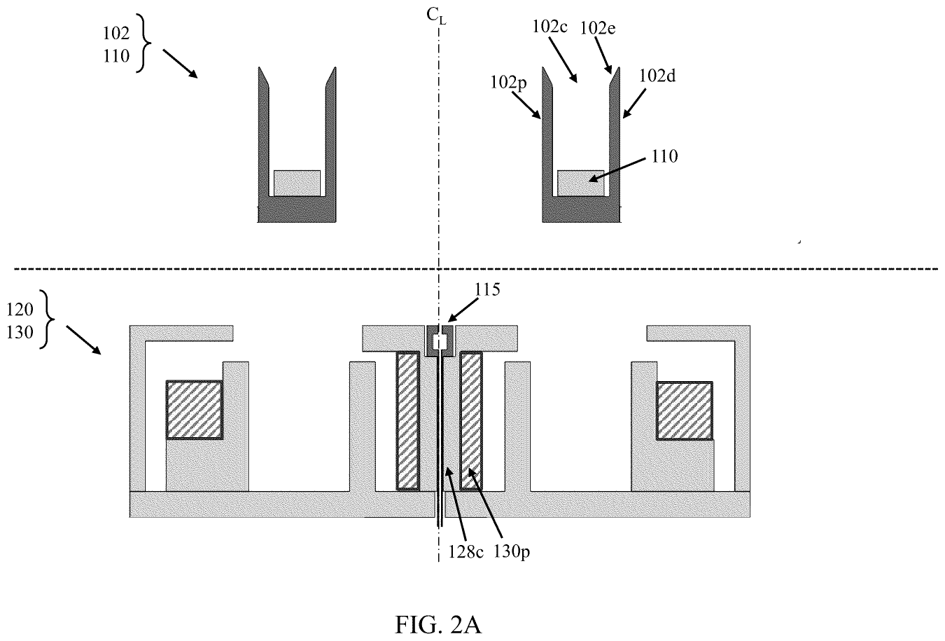

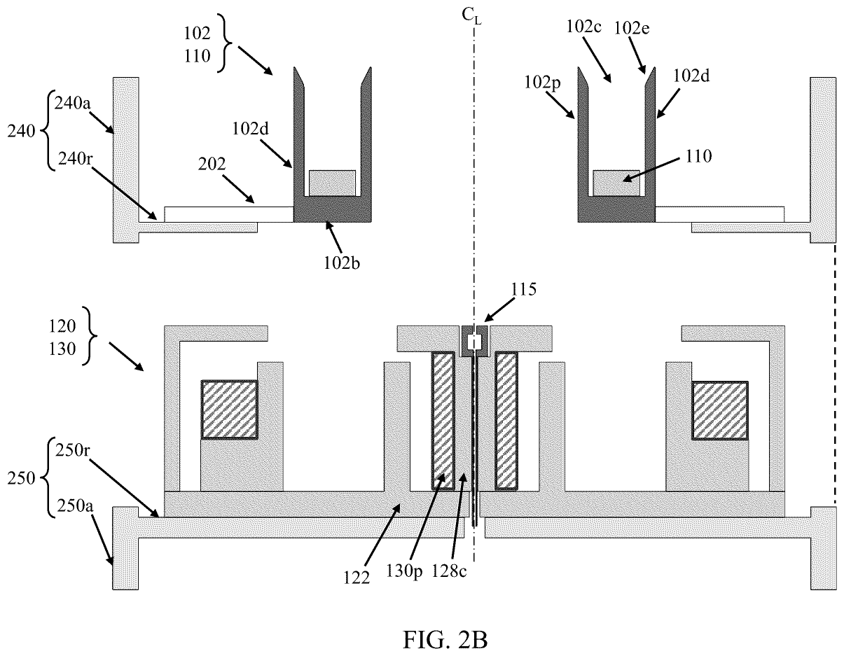

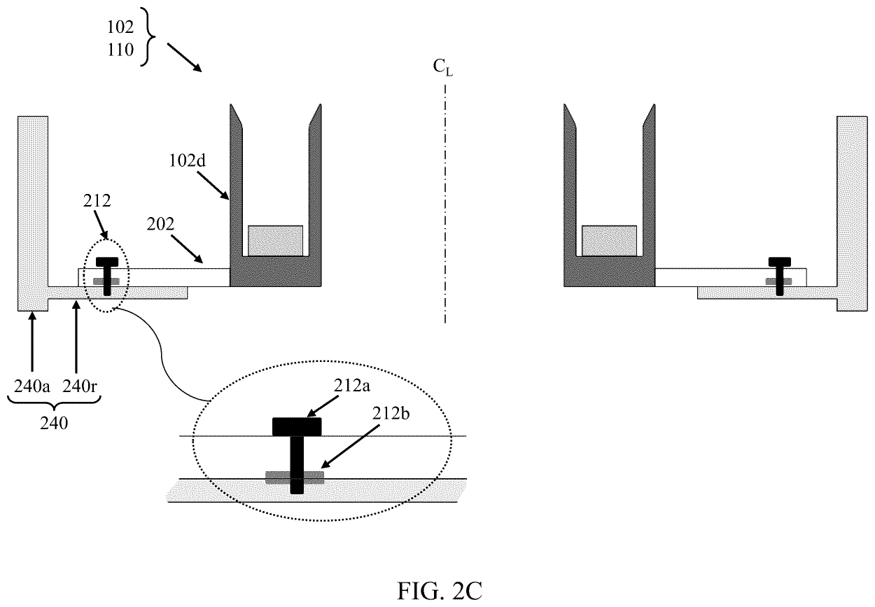

FIG. 2A shows partitioning of structures of an EP system, in this case a Hall thruster, considered for thermal management of a high-power density EP system according to the present disclosure. As shown in FIG. 2A, teachings according to the present disclosure partitions the EP system in separate sources of heat, including the discharge chamber (102) and anode (110, e.g., anode and gas distributor, discharge chamber assembly) as a first source of heat, and the electromagnetic circuit (120, 130) as a second source of heat. Thermal management of the EP system according to the present disclosure is therefore provided by two separate sets (e.g., physically, electrically and thermally separated) of thermal management structures (e.g., thermal shunts, radiators) that reject heat at different temperatures generated by the first/second sources of heat. Accordingly, heat from the two hottest regions of the thruster according to the present disclosure is decoupled, thereby allowing for more efficient sizing of the heat transfer components (e.g., thermal shunts, thermally conductive structures, heat conduction/rejection structures, etc.) and isolating such high-temperature regions from other parts of the thruster, allowing them to ultimately operate at lower temperatures. Such decoupling of the heat from the two hottest regions of the thruster may be provided by air gaps and/or an interfacing/interacting material having poor thermal conductivity (e.g., soft magnetic material). It should be noted that in the exemplary case of the Hall thruster shown in FIG. 2A, the cathode (115) arranged centrally in the magnetic core (120) may further contribute to the second source of heat.

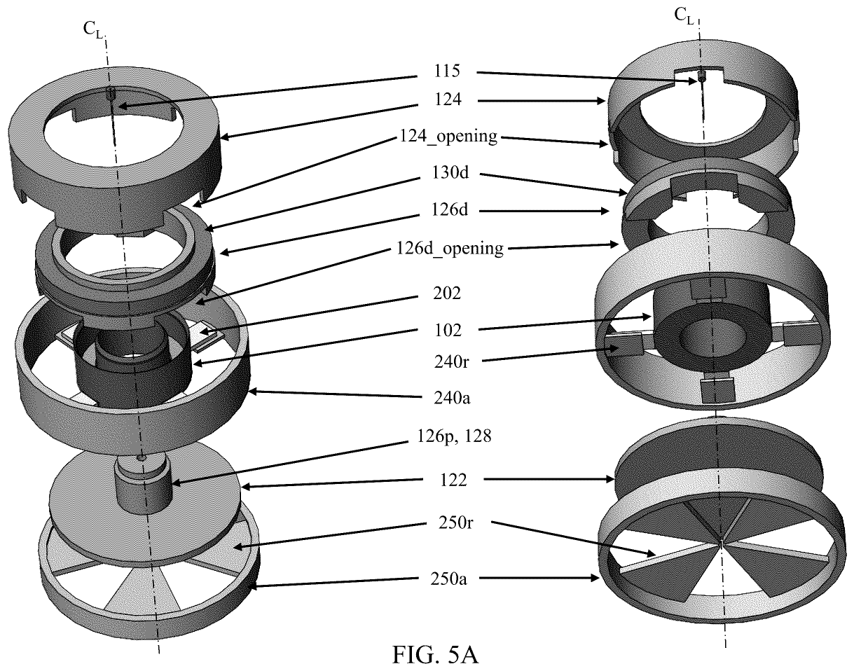

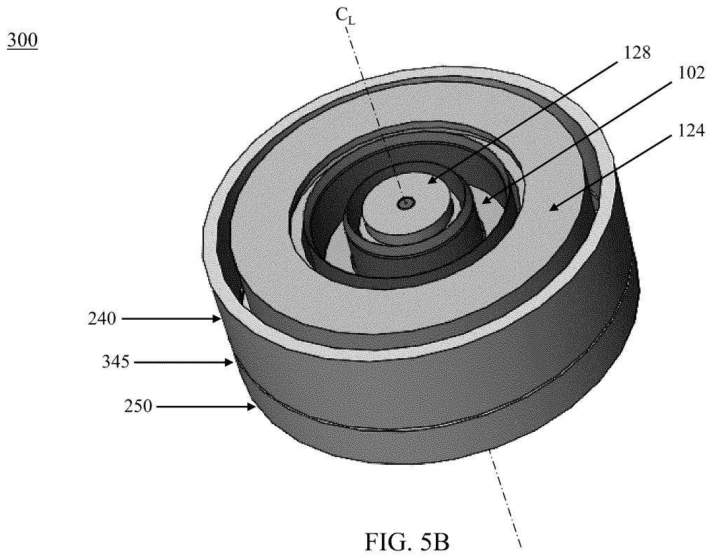

FIG. 2B shows details of thermally conductive structures of a high-power density EP system according to an embodiment of the present disclosure. These include, as shown in the top region of FIG. 2B, a first thermal shunt (202, 240r) that is connected on one side to the discharge chamber assembly (102, 110) and on the other side to a first radiator (240a). Further included, as shown in the bottom region of FIG. 2B, is a second thermal shunt (250r) connected on one side to an inner region of the electromagnetic circuit (120, 130) and on the other side to a second radiator (250a). In other words, the second thermal shunt (250r) extends from an outer radial position of the second radiator (250a) to an inner radial position of the inner electromagnetic (sub-) circuit (e.g., 128, 130p, 126p). It should be noted that although the cross-sectional view of FIG. 2B shows a single instance of each of the first (202, 240r) and second (250r) thermal shunts, teachings according to the present disclosure may use a plurality of each such thermal shunts in a radial arrangement as shown, for example, in the exploded views of FIGS. 5A/5B. Thermal shunts according to the present disclosure may be considered as transforming the underlying tubular/cylindrical structures (e.g., 102d, 240a, 250a) to which they are connected to spoked tubular/cylindrical structures as shown, for example, in the exploded views of FIGS. 5A/5B.

According to an exemplary embodiment of the present disclosure, connection of the (radial) thermal shunts (e.g., 202, 240r, 250r of FIG. 2B) according to the present disclosure to respective (axial, tubular) structures (e.g., 102, 240a, 250a) may be provided via standard low temperature fasteners (e.g., bolts, etc.). According to a preferred embodiment of the present disclosure, connection of the (radial) thermal shunts (e.g., 202, 240r, 205r) according to the present disclosure to respective (axial, tubular) structures (e.g., 102, 240a, 250a) may be provided via monolithic integration where structures are interconnected by way of atomic bonds, thereby resulting in a single monolithic structure.

As used herein, a monolithic structure may refer to a three-dimensional structure comprising functional elements bonded to one another via atomic bonds of a material (or materials) that makes the structure. This may therefore include a single material structure formed via subtractive manufacturing, a single or multi material structure formed via additive manufacturing, or a combination of the two. Accordingly, a monolithic structure according to the present disclosure may not include any fasteners/bolts or welding/glue to form a three-dimensional shape of the structure. By reducing (e.g., integrating) a plurality of internal (functional) elements (e.g., thermal shunts, radiators, chamber walls) of an EP system to a single monolithic structure, enhanced thermal conductivity of such structure, and therefore of an EP system using such structure, may be provided.

With continued reference to FIG. 2B, the first radiator (240a) is thermally coupled to the discharge chamber assembly (102, 110) via the first thermal shunt (202, 240r) for rejecting heat generated in the discharge chamber (102) and the anode (110), while the second radiator (250a) is thermally coupled to the (inner) electromagnetic circuit (120, 130) via the second thermal shunt (250r) for rejecting heat generated in the (inner) electromagnetic circuit (120, 130), including in the inner region (proximal to the center axis, CL) of the electromagnetic circuit (e.g., 128c, 130p of FIG. 1B).

According to an embodiment of the present disclosure, the first thermal shunt (202, 240r) may include an inner segment (202, e.g., inner thermal shunt segment) that radially protrudes the outer wall (102d) of the discharge chamber (102), and an outer segment (240r, outer thermal shunt segment) that is radially and axially aligned and in contact with the inner thermal shunt segment (202) on one side, and in contact with the second radiator (250a) on the other side.

According to an embodiment of the present disclosure, the inner thermal shunt segment (202) and the outer wall (102d) may be fabricated as a single monolithic part (e.g., structure). According to an embodiment of the present disclosure, the inner thermal shunt segment (202) radially protrudes the outer wall (102d) at an axial region of a discharge chamber baseplate (102b) upon which annular structures of the outer wall (102d) and the inner wall (102p) are fastened (e.g., bolted, fixated, mounted, connected, etc.). According to an embodiment of the present disclosure, the inner thermal shunt segment (202) radially protrudes the discharge chamber baseplate (102b). According to an embodiment of the present disclosure, the inner thermal shunt segment (202) and the discharge chamber baseplate (102b) may be fabricated as a single monolithic part. According to an embodiment of the present disclosure, the inner thermal shunt segment (202), the outer wall (102d), the inner wall (102p), and the discharge chamber baseplate (102b) may be fabricated as a single monolithic part. It should be noted that the anode (110) may also be fastened/mounted to the discharge chamber baseplate (102b).

With continued reference to FIG. 2B, according to an embodiment of the present disclosure, the outer thermal shunt segment (240r) and the first radiator (240a) may be fabricated as a single monolithic part (240). In other words, the first radiator may be considered as a radiator with integrated or monolithically integrated thermal shunts. Accordingly, the first radiator with integrated thermal shunts (240) may include a tubular structure (240a) having an (axial) extension according to the axial direction (e.g., as provided by CL), the tubular structure (240a) including a plurality of inwardly protruding structures (e.g., 240r, multiple instances as shown in FIG. 5A) having respective radial extensions sufficiently long to reach and connect to the inner thermal shunt segment (202).

With further reference to FIG. 2B, according to an embodiment of the present disclosure, the second thermal shunt (250r) and the second radiator (250a) may be fabricated as a single monolithic part (250). In other words, the second radiator may be considered as a radiator with integrated or monolithically integrated thermal shunts. Accordingly, the second radiator with integrated thermal shunts (250) may include a tubular structure (250a) having an (axial) extension according to the axial direction (e.g., as provided by CL), the tubular structure (250a) including a plurality of inwardly protruding structures (e.g., 250r, multiple instances as shown in FIG. 5A) having respective radial extensions sufficiently long to reach an inner region (e.g., 128c, 130p) of the electromagnetic circuit (120, 130).

It should be noted that as shown in, e.g., FIG. 2B, the inner thermal shunt segment (202) and the outer thermal shunt segment (240r) may include respective radial extensions that overlap over a substantial length. According to an exemplary embodiment of the present disclosure, such substantial length may represent at least half a distance between a radial position of the outer wall (102d) and a radial position of the first radiator (240a). Such overlap may allow for a higher thermal coupling between the two segments (202, 240r).

FIG. 2C shows details (212) according to an exemplary embodiment of the present disclosure for connecting of the thermally conductive structures of FIG. 2B. In particular, shown in FIG. 2C is a method according to the present disclosure for connecting of the inner thermal shunt segment (202) to the outer thermal shunt segment (240r) via a fastener (212a). Because the connection is made at a region distal to the discharge chamber (102) that is the source of heat, and proximal to the tubular structure of the first radiator (240a) that rejects the heat, then the connection is made at a region of low temperature (e.g., substantially lower than the temperature of 102, 110) and through a high-contact conductance interface (212b). Accordingly, a standard low temperature fastener (212a) may be used. According to a nonlimiting exemplary embodiment of the present disclosure, the high-contact conductance interface (212b) may be provided via a high-temperature flexible gasket material that may increase contact area (e.g., between the two structures 202, 240r) and therefore increase heat transfer characteristics of the interface. Teachings according to the present disclosure may use different materials and contact methods with the goal to increase thermal conductance between different heat transfer structures (e.g., shunts, radiators).

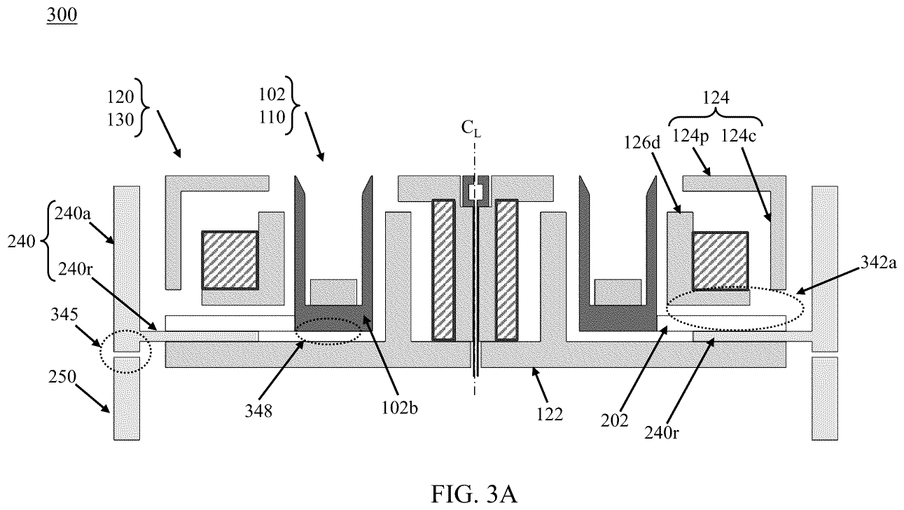

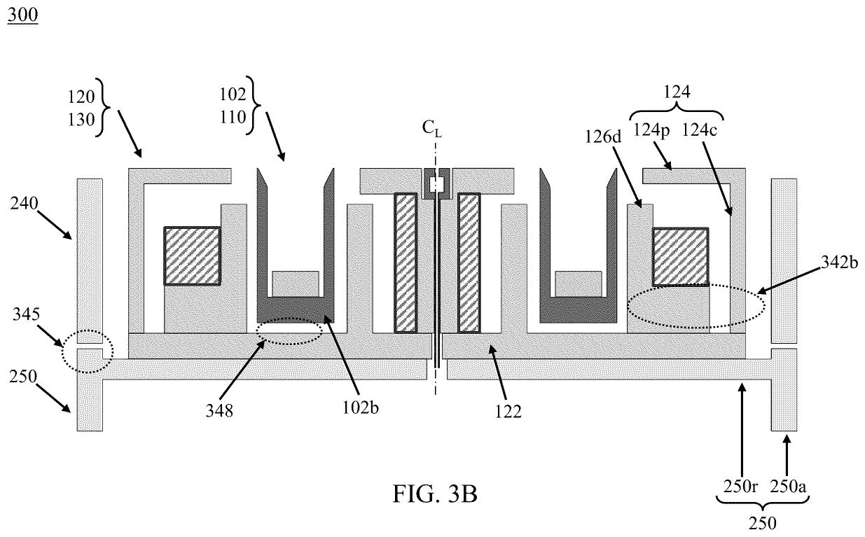

FIG. 3A shows a simplified cross-sectional schematic of the high-power density EP system (300) according to an embodiment of the present disclosure at a first angular view, and FIG. 3B shows a simplified cross-sectional schematic of the high-power density EP system according to an embodiment of the present disclosure at a second angular view. Such angular views represent cross sectional views of the high-power density EP system according to the present disclosure in an assembled state, including the first/second radiators and thermal shunts described above with reference to FIG. 2B.

As shown in the first angular view of FIG. 3A, at a region of the first thermal shunt (202, 240r), there exists an opening (342a) in elements of the magnetic core (120) through which the first thermal shunt (202, 240r) radially projects (e.g., protrudes, emanates) to reach the first radiator (240a). According to an embodiment of the present disclosure, the opening (342a) is provided by respective openings (e.g., 124_opening and 126d_opening of FIG. 5A, cutouts) formed in the outer core structure (124) and the outer screen (126d). In other words, at a first angular position that corresponds to the first angular view shown in FIG. 3A, the outer core structure (124) and the outer screen (126d) do not make contact with the baseplate (122) of the magnetic core (120).

On the other hand, as shown in the second angular view of FIG. 3B, at a region (e.g., 342b) of the magnetic core (120) that is devoid of any first thermal shunts (202, 240r), all elements of the magnetic core (120), including the outer core structure (124) and the outer screen (126d), make contact with the baseplate (122) of the magnetic core (120). In other words, and as shown in the exploded views of FIG. 5A, the outer core structure (124) and the outer screen (126d) may include respective tubular (e.g., axial) structures having respective plurality of cutouts (e.g., 124_opening, 126d_opening of FIG. 5A) at the bottom region where contact is to be made with the baseplate (122). Such cutouts configured to (radially) align in an assembled state of the high-power density EP system (300) according to the present disclosure to allow radial projection of the first thermal shunts (202, 240r).

It should be noted that the second thermal shunt (250r) does not appear in the first angular position that corresponds to the first angular view shown in FIG. 3A but does appear in the second angular position that corresponds to the second angular view shown in FIG. 3B. In other words, according to an embodiment of the present disclosure, an angular position of the first thermal shunt (202, 240r) is different from an angular position of the second thermal shunt (250r). In other words, according to an embodiment of the present disclosure, the first thermal shunt (202, 240r) and the second thermal shunt (250r) do not radially overlap. In other words, according to an embodiment of the present disclosure, the first thermal shunt (202, 240r) and the second thermal shunt (250r) are positioned at different angular positions or different ranges of angular positions. In other words, a projection of the first thermal shunt (202, 240r) onto the plane of the baseplate (122) does not overlap a projection of the second thermal shunt (250r) onto the plane of the baseplate (122). In other words, a region of the baseplate (122) that is defined/delimited by a top surface in contact with the first thermal shunt (202, 240r), does not include a corresponding bottom surface in contact with the second thermal shunt (250r), and vice versa.

Such angular decoupling (e.g., distancing) of the first thermal shunt (202, 240r) from the second thermal shunt (250r) may further establish possible separation/division/segmentation of the respective thermal management for the discharge chamber assembly (102, 110) and the (inner) electromagnetic circuit (120, 130). Further separation/division/segmentation of the respective thermal management may be provided by a gap (345, e.g., air gap, axial gap) that as shown in FIGS. 3A/3B axially separates/distances the first radiator (240) from the second radiator (250). It should be noted that such gap (345) is present at all angular positions, and therefore throughout an outer circumference of the first (240) and second (250) radiators as also shown in the perspective view of the assembled EP system (300) of FIG. 5B. According to a nonlimiting embodiment of the present disclosure, the gap (345) may be located at an axial region of the baseplate (122), or in other words, an axial position of the gap (345) may be within an axial extension of the baseplate (122). Yet further separation/division/segmentation of the respective thermal management may be provided by a poor thermal conductivity of a (e.g., soft magnetic) material of the baseplate (122) that makes contact with the first (240, FIG. 3A) and second (250, FIG. 3B) radiators. Resulting poor thermal conductivity across the baseplate (122) may further reduce cross coupling of heat generated by the discharge chamber assembly (102, 110) and the inner electromagnetic circuit (e.g., elements 128, 130p, 126p).

Further separation/division/segmentation of the respective thermal management may be provided by a gap (348, e.g., air gap) that as shown in FIGS. 3A/3B axially separates/distances the discharge chamber assembly (102, 110) from the electromagnetic circuit (120, 130). In particular, as shown in FIGS. 3A/3B, the discharge chamber baseplate (102b) is axially separated/distanced from the baseplate (122) of the magnetic core (120) by the gap (348). It should be noted that such gap (348) is present at all angular positions. In other words, the discharge chamber assembly (102, 110) is mechanically supported by the first radiator (240) which is mechanically supported by the baseplate (122). In other words, the discharge chamber assembly (102, 110) is not in (direct) physical contact with the magnetic core (120), including any of the structures (122, 124, 126). Such separation between the discharge chamber assembly (102, 110, e.g., discharge chamber 102) and the magnetic core (120) may advantageously allow a reduction in heat flow from the hotter discharge chamber assembly (102, 110) to the cooler magnetic core (120). According to an embodiment of the present disclosure, the gap (348) may be provided by (e.g., filled with) a poor thermal conductivity material that may accordingly make (physical) contact with the discharge chamber assembly (102, 110) and the baseplate (122) while thermally isolating the discharge chamber assembly (102, 110) from the baseplate (122).

According to an embodiment of the present disclosure, the thermal shunts according to the present disclosure, including the above-described structures (202, 240r, 250r), can be made from high thermal conductivity materials. According to another embodiment of the present disclosure, the thermal shunts according to the present disclosure, including the above-described structures (202, 240r, 250r), can include embedded heat pipes. According to yet another embodiment of the present disclosure, the thermal shunts according to the present disclosure, including the above-described structures (202, 240r, 250r), can be made from electrically conducting or insulating materials. According to an embodiment of the present disclosure, the thermal shunts according to the present disclosure, including the above-described structures (202, 240r, 250r), can be made from materials that are different from materials of the structures (e.g., 102, 240a, 250a) to which they connect.

Because the high-power density EP system according to the present disclosure (e.g., 300 of FIGS. 3A/3B) includes a discharge chamber (102) that is made from electrically conducting material, and therefore includes electrically conducting walls and baseplate (e.g., 102d, 102p and 102b of FIG. 2B), then during operation of the EP system, the discharge chamber (102) may be at a high voltage (e.g., in a range from 150 V to 1000 V). Teachings according to the present disclosure electrically isolate such high voltage from other structures/elements of the EP system via a material choice (e.g., electrically conductive or insulating) of the thermal shunts (e.g., 202, 240r, 250r) and/or the radiators (e.g., 240a, 250a), and/or a coating of such thermal shunts and/or radiators with an insulating material having a high dielectric constant (e.g., to prevent electrical breakdown), such as a ceramic material. It should be noted that the other structures/elements of the EP system may include electrically conductive structures/elements (e.g., the magnetic core 120, the radiators 240 and/or 250) that may carry lower voltages, such as zero volts (e.g., grounded).

With reference back to FIGS. 3A/3B, according to an embodiment of the present disclosure, electrical isolation of the discharge chamber (102) high voltage may be provided by the inner thermal shunt segment (202) made from an electrically non-conductive material (i.e., electrically insulating material). Accordingly, any one of: the outer thermal shunt segment (240r), the first radiator (240a), the second radiator (250a), and the second thermal shunt (250r), may be made from an electrically conductive or non-conductive material. According to an exemplary embodiment of the present disclosure, elements (240a, 240r, 250a, 250r) may be made from an electrically conductive material. According to an exemplary embodiment of the present disclosure, elements (240a, 240r) may be monolithically integrated into a single part (e.g., first radiator 240) made of an electrically conductive material. According to an exemplary embodiment of the present disclosure, elements (250a, 250r) may be monolithically integrated into a single part (e.g., second radiator 250) made of an electrically conductive material.

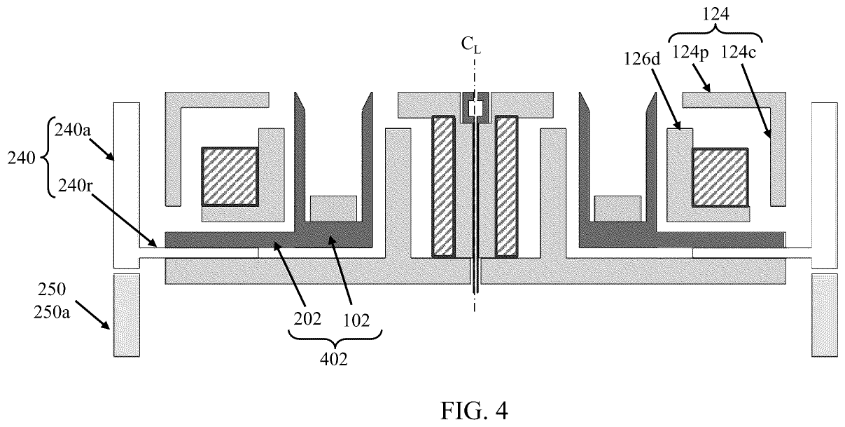

According to an embodiment of the present disclosure, and as shown in FIG. 4, the inner thermal shunt segment (202) may be made from an electrically conductive material. In such configuration, because the inner thermal shunt segment (202) may carry the high voltage of the discharge chamber (102), then electrical isolation of such high voltage may be provided by the outer thermal shunt segment (240r) made from an electrically non-conductive material (i.e., electrically insulating material). In such configuration, the first radiator (240a) may also be made from an electrically insulating material, and the second radiator (250a) and the second thermal shunt (250r, not shown in FIG. 4) may be made from an electrically conductive or non-conductive/insulating material. According to an exemplary embodiment of the present disclosure, elements (102, 202) may be monolithically integrated into a single part (e.g., discharge chamber or chamber assembly with integrated thermal shunts) made of an electrically conductive material. According to an exemplary embodiment of the present disclosure, elements (240a, 240r) may be monolithically integrated into a single part (e.g., first radiator 240) made of an electrically insulating material. According to an exemplary embodiment of the present disclosure, elements (250a, 250r) may be monolithically integrated into a single part (e.g., second radiator 250) made of an electrically conductive material.

According to an embodiment of the present disclosure, electrical isolation of the discharge chamber (102) high voltage may be provided by the inner and/or outer thermal shunt segments (202, 240r) made from an electrically conductive material and encased in an outer coating/jacket/covering that is made from an electrically insulating material (e.g., a ceramic material). Such configuration may allow monolithic integration (e.g., via additive/subtractive manufacturing) of either one of (102, 202) and/or (240a, 240r) for derivation of corresponding single parts, and subsequent coating of the corresponding thermal shunt segments (202) and/or (240r). Alternatively, such monolithic integration may be provided via additive manufacturing (e.g., a first phase manufacturing) from a highly electrically conductive material such as, for example, graphite, and then transitioning (e.g., a second phase manufacturing) to an electrically insulating material such as, for example, silicon carbide, to provide insulating sections and/or surface regions of the thermal shunts (e.g., 202 and/or 240r). According to an exemplary embodiment of the present disclosure, electrical isolation between two structures (e.g., 202, 240r) at different voltages, including for example an electrically conductive first structure (e.g., 202) coated with an electrically insulating material, that may be fastened to one another via a fastener (e.g., according to above-described fastener 212 of FIG. 2C) may be further provided via application of an electrically insulating coating on inner walls of a hole/channel of the first structure through which the fastener extends.

FIG. 5A shows exploded top and bottom views of the high-power density EP system (300) of FIG. 3A and FIG. 3B, and FIG. 5B shows the high-power density EP system (300) of FIG. 3A and FIG. 3B in an assembled state. Clearly shown in FIG. 5A is the radial and axial alignment of the openings/cutouts (e.g., labeled as 124_opening and 126d_opening) of the structures (124) and (126d) that allow inwardly/outwardly radial projection of the first thermal shunt (202, 240r). Also shown in FIG. 5A, are the relative angular positions of the first (202, 240r) and second (250r) thermal shunts such as to produce non-overlapping respective radial extensions. As shown in FIG. 5A, the exemplary EP system (300) may include four instances of the first (202, 240r) and second (250r) thermal shunts, instances of each set arranged in quadrature about the corresponding structures (e.g., 102, 240a, 250a). As shown in FIG. 5A, the thermal shunts (250r) may inwardly extend near the center axis of the EP system so to reach the hot regions of the inner electromagnetic circuit (e.g., 128, 126p) and cathode (115) while allowing for a center opening for feeding/energizing of the cathode (115). As previously described in the present disclosure, the combination of the thermal shunts, including the first thermal shunt (202, 240r), with the openings/cutouts (e.g., 124_opening, 126d_opening) may allow to accurately position/align the various parts/structures relative to each other to systematically (mass) produce/assemble the assembled high-power density EP system (300) shown in FIG. 5B.

The high-power density EP system according to the present disclosure (e.g., 300 of FIG. 5B) offers novel capabilities by using high-emissivity materials and greatly enhanced conductive heat rejection to couple the high temperature of the discharge chamber (e.g., 102) and electromagnetic circuit (e.g., 120, 130) with the first (202, 240r) and second (250r) thermal shunts connected to a segmented radiator (e.g., first and second radiators, 240a and 250a, as first and second segments) that effectively thermally manages two different temperature zones. The dual-temperature zones of the segmented radiator allow for independent optimization of elements/structures used for the thermal management and decouple the hottest portions of the thruster from other thermally sensitive parts. Teachings according to the present disclosure further enable mass optimization of various elements/structures of the electromagnetic circuit (120, 130) since the thermal management of the circuit no longer depends on their conducting cross-sections. Furthermore, teachings according to the present disclosure may provide an EP system not only capable of operation at higher power densities but also with a reduced mass, parts count, and cost when compared to a prior art EP system.

The ability to operate at high power densities provided by the EP system according to the present teachings is critical to achieving large power throttling ratios at high specific impulse. Without this capability, thrusters encounter plasma instabilities at reduced current, forcing throttling of the voltage, which decreases specific impulse. The high-power density EP system according to the present teachings can achieve power throttling ratios of at least 2:1 at high specific impulse (e.g., greater than 3000 s). Furthermore, the high-power density EP system according to the present teachings can maintain at least 50-70% thrust efficiency over 5:1 power throttling ratios and an unprecedented 50:1 power throttling ratio across the entire operating range of the thruster.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A high-power density electric propulsion (EP) system, comprising:
a discharge chamber with a longitudinal extension according to an axial direction of the EP system, the discharge chamber comprising an annular inner wall and an annular outer wall made of an electrically conductive material;
an electromagnetic circuit for generation in the discharge chamber of a magnetic field according to a radial direction;
a segmented annular radiator surrounding the discharge chamber and the electromagnetic circuit; and
a plurality of first thermal shunts radially outwardly projecting from the annular outer wall of the discharge chamber to make contact with the segmented annular radiator.

2. The high-power density electric propulsion (EP) system of claim 1, wherein:
the segmented annular radiator comprises a first annular radiator segment and a second annular radiator segment, and
the first annular radiator segment is separated from the second annular radiator segment by an axial gap.

3. The high-power density electric propulsion (EP) system of claim 2, wherein:
the plurality of first thermal shunts make contact with the first annular radiator segment.

4. The high-power density electric propulsion (EP) system of claim 3, wherein:
a longitudinal extension of the first annular radiator segment encompasses the longitudinal extension of the discharge chamber.

5. The high-power density electric propulsion (EP) system of claim 2, wherein:
the plurality of first thermal shunts are substantially thermally decoupled from the second annular radiator segment.

6. The high-power density electric propulsion (EP) system of claim 1, wherein:
each thermal shunt of the plurality of first thermal shunts comprises an inner thermal shunt segment connected to an outer thermal shunt segment,
the inner thermal shunt segment is further connected to the annular outer wall of the discharge chamber, and
the outer thermal shunt segment is further connected to the segmented annular radiator.

7. The high-power density electric propulsion (EP) system of claim 6, wherein:
the inner thermal shunt segment is electrically conductive, and
the outer thermal shunt segment is electrically non-conductive.

8. The high-power density electric propulsion (EP) system of claim 7, wherein:
the inner thermal shunt segment is coated with an electric insulator.

9. The high-power density electric propulsion (EP) system of claim 7, wherein:
the inner thermal shunt segment is coated with a ceramic material.

10. The high-power density electric propulsion (EP) system of claim 6, wherein:
the inner thermal shunt segment is electrically non-conductive, and
the outer thermal shunt segment is electrically conductive.

11. The high-power density electric propulsion (EP) system of claim 6, wherein:
the inner thermal shunt segment is fastened to the outer thermal shunt segment at a radial position that is distal to the annular outer wall of the discharge chamber and proximal to the segmented annular radiator.

12. The high-power density electric propulsion (EP) system of claim 11, wherein:
the inner thermal shunt segment is fastened to the outer thermal shunt segment via a standard low temperature fastener.

13. The high-power density electric propulsion (EP) system of claim 6, wherein:
the inner thermal shunt segment and the annular outer wall of the discharge chamber are monolithically integrated into one structure.

14. The high-power density electric propulsion (EP) system of claim 13, wherein:
the inner thermal shunt segment and the annular outer wall of the discharge chamber are monolithically integrated into one structure via additive manufacturing, and
the additive manufacturing comprises a first phase manufacturing via a highly electrically conductive material followed by a second phase manufacturing via an electrically insulating material, the second phase manufacturing configured to provide an insulating region of the inner thermal shunt segment.

15. The high-power density electric propulsion (EP) system of claim 6, wherein:
the inner thermal shunt segment, the annular inner wall of the discharge chamber, and the annular outer wall of the discharge chamber are monolithically integrated into one structure.

16. The high-power density electric propulsion (EP) system of claim 1, wherein:
the electromagnetic circuit comprises a magnetic core made of a magnetic material, the magnetic core comprising an inner core structure, an outer core structure, and a baseplate, the inner and outer core structures arranged atop the baseplate, and
an axial extension of the outer core structure comprises a plurality of openings through which the plurality of first thermal shunts project to make contact with the segmented annular radiator.

17. The high-power density electric propulsion (EP) system of claim 16, wherein:
the segmented annular radiator is separated from the magnetic core by an air gap.

18. The high-power density electric propulsion (EP) system of claim 16, wherein:
the magnetic core further comprises an outer screen structure arranged atop the baseplate at a radial position between the discharge chamber and the outer core structure, and
an axial extension of the outer screen structure comprises a plurality of openings aligned with the plurality of openings of the outer core structure for projection of the plurality of first thermal shunts.

19. The high-power density electric propulsion (EP) system of claim 16, wherein:
the discharge chamber is separated from the magnetic core, and
each thermal shunt of the plurality of first thermal shunts is
separated from the magnetic core at a region proximal to the discharge chamber, and
in contact with the magnetic core at a region distal to the discharge chamber.

20. The high-power density electric propulsion (EP) system of claim 16, wherein:
each thermal shunt of the plurality of first thermal shunts comprises an inner thermal shunt segment connected to an outer thermal shunt segment, and
the inner thermal shunt segment is connected to the annular outer wall of the discharge chamber and separated from the magnetic core.

21. The high-power density electric propulsion (EP) system of claim 20, wherein:
the outer thermal shunt segment is connected to the segmented annular radiator and in contact with the magnetic core.

22. The high-power density electric propulsion (EP) system of claim 16, further comprising:
a plurality of second thermal shunts radially inwardly projecting from the segmented annular radiator to make contact with the baseplate at a radial position proximal to the inner core structure.

23. The high-power density electric propulsion (EP) system of claim 22, wherein:
the segmented annular radiator comprises a first annular radiator segment and a second annular radiator segment separated from one another by an axial gap,
the plurality of first thermal shunts make contact with the first annular radiator segment, and
the plurality of second thermal shunts make contact with the second annular radiator segment.

24. The high-power density electric propulsion (EP) system of claim 23, wherein:
the axial gap is located at an axial region of the baseplate.

25. The high-power density electric propulsion (EP) system of claim 23, wherein:
respective angular positions of the plurality of first thermal shunts are different from respective angular positions of the plurality of second thermal shunts.

26. The high-power density electric propulsion (EP) system of claim 23, wherein:
the plurality of first thermal shunts consists of four first thermal shunts arranged in quadrature, and
the plurality of second thermal shunts consists of four second thermal shunts arranged in quadrature.

27. The high-power density electric propulsion (EP) system of claim 23, wherein:
the EP system is a magnetically shielded Hall thruster.

28. A high-power density magnetically shielded Hall thruster, comprising:
a discharge chamber with a longitudinal extension according to an axial direction of the Hall thruster, the discharge chamber made of an electrically conductive material;
an electromagnetic circuit for generation in the discharge chamber of a magnetic field according to a radial direction, the electromagnetic circuit comprising an inner electromagnetic circuit and an outer electromagnetic circuit;
a segmented annular radiator surrounding the outer electromagnetic circuit;
a plurality of first thermal shunts radially outwardly projecting from the discharge chamber to make contact with a first segment of the segmented annular radiator through respective plurality of openings formed in the outer electromagnetic circuit; and
a plurality of second thermal shunts radially inwardly projecting from a second segment of the segmented annular radiator that is separate from the first segment to make contact with the inner electromagnetic circuit.

29. A method for operating a magnetically shielded Hall thruster at higher power densities, the method comprising:
fabricating a discharge chamber of the Hall thruster from electrically conductive material;
forming a plurality of openings in an outer electromagnetic circuit of the Hall thruster and arranging the outer electromagnetic circuit outwardly the discharge chamber;
arranging an inner electromagnetic circuit of the Hall thruster inwardly the discharge chamber;
arranging a segmented annular radiator outwardly the outer electromagnetic circuit;
radially outwardly projecting a plurality of first thermal shunts from the discharge chamber to make contact with a first segment of the segmented annular radiator through the plurality of openings;
radially inwardly projecting a plurality of second thermal shunts from a second segment of the segmented annular radiator that is separate from the first segment to make contact with the inner electromagnetic circuit;
based on the radially outwardly projecting and the radially inwardly projecting, rejecting heat generated at the discharge chamber and the inner electromagnetic circuit independently from one another, thereby increasing efficiency of thermal management of the Hall thruster; and
based on the increasing efficiency of thermal management, operating the Hall thruster at higher power densities.
